(19) United States
(12) Patent Application Publication
(10) Pub. No.: US 2009/0261725 A1
(43) Pub. Date: Oct. 22, 2009

(54) SIDE-VIEW LIGHT EMITTING DIODE

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/184,244

(22) Filed: Jul. 31, 2008

(30) Foreign Application Priority Data
Apr. 18, 2008 (CN) 200810066831.3

(51) Int. Cl. H01J 1/62

(52) U.S. Cl. 313/512

(57) ABSTRACT

A side-view light emitting diode includes a substrate, a tubular, upwardly tapered light permeable housing disposed on the substrate, a receiving space formed between the substrate and the housing, a light emitting diode chip received in the receiving space, a light permeable capsulation material filled in the receiving space and encapsulating the light emitting diode chip in the housing, and a flat reflecting layer formed on a top end of the capsulation material. The housing forms a plurality of annular projections projecting outwardly. An outer surface of the housing has a coarse feature.

### BACKGROUND

1. Field of the Invention

The present invention relates to light emitting diodes, and particularly to a side-view light emitting diode.

2. Description of Related Art

Presently, LEDs (light emitting diodes) are preferred for use in the non-emissive display devices rather than CCFLs (cold cathode fluorescent lamps) due to high brightness, long life-span, and wide color range.

A related side-view light emitting diode includes a substrate, a transparent housing disposed on the substrate, a LED chip disposed on the substrate and in the housing, an electrode located on the LED chip, a gold wire electrically connecting the electrode with the substrate, and a capsulation material filled in the housing and encapsulating the LED chip, the electrode and the gold wire in the housing.

In operation of the related light emitting diode, one part of light emitted by the LED chip directly shoots toward the sidewall of the housing and leaves the housing from the sidewall. The other part of the light from the LED chip firstly shoots toward a top end of the housing, and is reflected toward the sidewall of the housing, and leaves the housing from the sidewall.

In order for reflecting more light toward the sidewall of the housing, a top end of the capsulation material defines an inverted taper indent therein for increasing the incident angle of the light shot toward the top end of the housing, and further inducing more light to be reflected toward the sidewall of the housing due to a total reflection phenomena of the light. However, it is complicated to form the indent in the top end of the capsulation material. Moreover, it is complicated to manufacture a side surface of the indent to be a smooth surface, which induces some light to leave the light emitting diode from the top end of the capsulation material and decreases the extracting rate of the light from the sidewall of the light emitting diode.

What is need, therefore, is a side-view light emitting diode which has higher extracting rate of the light than the related side-view light emitting diode.

### SUMMARY

The present invention provides a side-view light emitting diode. An exemplary side-view light emitting diode includes a substrate, a light permeable, tapered, tube-shaped housing disposed on the substrate, a receiving space formed between the substrate and the housing, a light emitting diode chip received in the receiving space, a light permeable capsulation material filled in the receiving space and encapsulating the light emitting diode chip in the housing, and a reflecting layer formed on a top end of the capsulation material. The housing is tapered upwardly. The housing is formed with a plurality of annular projections projecting outwardly. An outer surface of the housing is processed to have a coarse feature.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is an isometric view of a side-view light emitting diode according to an exemplary embodiment of the present invention.

FIG. 2 is a sectional view of the light emitting diode of FIG. 1.

### DETAILED DESCRIPTION

Reference will now be made to the drawing figures to describe the exemplary embodiment in detail.

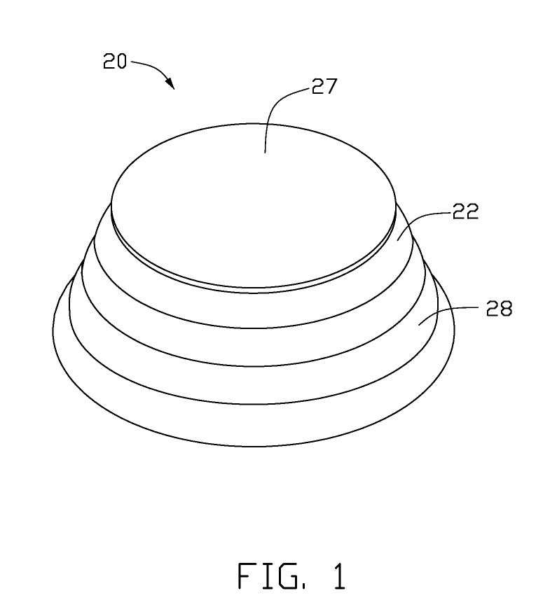

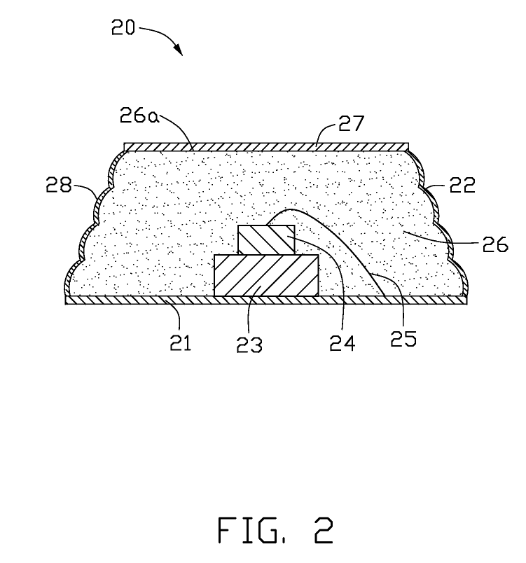

Referring to FIGS. 1 and 2, a side-view light emitting diode (LED) 20 according to an exemplary embodiment of the present invention is shown. The light emitting diode 20 includes a substrate 21, a tapered, tube-shaped housing 22, a LED chip 23, an electrode 24, a gold wire 25 and a capsulation material 26.

The substrate 21 is made of materials having electric and thermal conductivities. In this embodiment, the substrate 21 is made of metal such as aluminum or copper.

The housing 22 is tapered upwardly. The housing 22 is made of light permeable materials, such as epoxy resin or glass. A horizontal section of the housing 22 has an annular shape, and a vertical section of the housing 22 has a substantially trapezoidal shape. A diameter of the housing 22 gradually decreases from a bottom end toward a top end thereof. The housing 22 is located on the substrate 21, thereby forming a receiving space (not labeled) between the substrate 21 and the housing 22.

The LED chip 23 has a substantially rectangular shape. The LED chip 23 is disposed in the receiving space between the substrate 21 and the housing 22, and is adhered to the substrate 21 via silver colloid.

The electrode 24 has a substantially rectangular shape. The electrode 24 is arranged on the LED chip 23 and electrically connects with the substrate 21 via the gold wire 25. The substrate 21 electrically connects with an external power supply (not shown) via pins (not shown) extending outwardly from the substrate 21 so that the LED chip 23 can electrically connect with the power supply.

The capsulation material 26 is made of light permeable materials, such as epoxy resin, glass or silicone gel. The capsulation material 26 is filled in the receiving space and has a configuration matched with the housing 22. The capsulation material 26 encapsulates the LED chip 23, the electrode 24 and the gold wire 25 in the receiving space. A top end of the capsulation is coplanar with a top end of the housing 22.

A flat reflecting layer 27 is formed on a top end 26a of the capsulation material 26, for reflecting the light emitted from the LED chip 23 toward a side periphery of the capsulation material 26 and the housing 22. The material of the reflecting layer 27 is aluminum or sliver.

The housing 22 forms four consecutive annular projections 28 along a bottom-to-top direction. The projections 28 project outwardly. The capsulation material 26 correspondingly has four annular projections formed on the side periphery thereof. A vertical section of the housing 22 has two opposite sides each of which is wave-shaped, and a vertical section of each projection 28 has two opposite sides each of which is arc-shaped. Diameters of the annular projections 28 gradually decrease from a bottom end towards a top end of the housing 22. In addition, there is a plurality of bulge points or tiny indents formed on an outer surface of the housing 22, whereby the outer surface of the housing 22 can be a coarse surface so as to increase an extracting rate of the light emitted from the LED chip 23 by the housing 22.

In operation of the present light emitting diode 20, one part of the light emitted by the LED chip 23 directly shoots toward the side periphery of the capsulation material 26 and the housing 22 and leaves the capsulation material 26 and the housing 22 from the side periphery of the capsulation material 26 and the outer surface of the housing 22. The other part of the light from the LED chip 23 firstly shoots toward the top end 26a of the capsulation material 26, and is reflected by the reflecting layer 27 toward the side periphery of the capsulation material 26 and the housing 22, and finally leaves the light emitting diode 20 via the outer surface of the housing 22.

In the present light emitting diode 20, the vertical section of the housing 22 is trapezoid-shaped, with a plurality of annular projections 28; furthermore, the outer surface of the housing 22 is processed to have a coarse feature; therefore, the extracting rate of the light emitted from LED chip 23 impinged on the housing 22 by the housing 22 is increased. Furthermore, the reflecting layer 27 spread on the top end of the capsulation material 26 reflects more light toward the side periphery of the capsulation material 26 and the housing 22 as compared to the related light emitting diode, which further increases the extracting rate of the light by the side periphery of the capsulation material 26 and the housing 22.

It is to be understood, how ever, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A side-view light emitting diode comprising:
a substrate;
a tube-shaped light permeable housing disposed on the substrate;
a receiving space formed between the substrate and the housing;
a light emitting diode chip received in the receiving space and electrically connected with the substrate;
a light permeable capsulation material filled in the receiving space and encapsulating the light emitting diode chip in the housing; and
a flat reflecting layer formed on a top end of the capsulation material for reflecting light toward an outer surface of the housing, from which the light leaves the light emitting diode.

2. The side-view light emitting diode of claim 1, wherein the housing is tapered upwardly and a vertical section of the housing has a trapezoidal shape.

3. The side-view light emitting diode of claim 1, wherein the outer surface of the housing is a coarse surface.

4. The side-view light emitting diode of claim 3, wherein the housing is formed with a plurality of annular projections projecting outwardly.

5. The side-view light emitting diode of claim 4, wherein the annular projections are consecutive along a bottom-to-top direction of the housing.

6. The side-view light emitting diode of claim 4, wherein a vertical section of each projection has two opposite sides each of which is arc-shaped.

7. The side-view light emitting diode of claim 4, wherein diameters of the annular projections gradually decrease from a bottom end towards a top end of the housing.

8. The side-view light emitting diode of claim 1, wherein a vertical section of the housing has two opposite sides each of which is wave-shaped.

9. A side-view light emitting diode comprising:
a substrate;
a light emitting diode chip mounted on the substrate;
a light permeable capsulation material located on the substrate and encapsulating the light emitting diode chip therein;
a flat reflecting layer formed on a top end of the capsulation material; and
a plurality of annular projections disposed at a side periphery of the capsulation material.

10. The side-view light emitting diode of claim 9, wherein a vertical section of the capsulation material has a substantially trapezoidal shape with a bottom side larger than a top side thereof.

11. The side-view light emitting diode of claim 9, wherein the projections are consecutive along a bottom-to-top direction of the capsulation material.

12. The side-view light emitting diode of claim 9, wherein a vertical section of each of the projections has two opposite sides each of which is arc-shaped.

13. The side-view light emitting diode of claim 9, wherein diameters of the annular projections gradually decrease from a bottom end towards a top end of the capsulation material.

14. The side-view light emitting diode of claim 9, wherein a vertical section of the side periphery of the capsulation material has two opposite sides each of which is wave-shaped.
